(19) United States
(12) Patent Application Publication
(10) Pub. No.: US 2019/0142223 A1
(43) Pub. Date: May 16, 2019

(54) DRAMATIC AND EASY TO COOK AND SERVE DEBONED WHOLE FISH

(71) Applicants: Douglas B. HALL, Newtown, OH (US); Michael SIROIS, Portsmouth, NH (US)

(72) Inventors: Douglas B. HALL, Newtown, OH (US); Michael SIROIS, Portsmouth, NH (US)

(21) Appl. No.: 16/300,264

(22) PCT Filed: May 10, 2017
(86) PCT No.: PCT/US17/31951

§ 371 Date: Nov. 9, 2018

Related U.S. Application Data
(60) Provisional application No. 62/334,030, filed on May 10, 2016.

(51) Int. Cl. A47J 43/18; A23L 17/00; A47G 19/30; A22C 25/08; A22C 25/18; A22C 25/14; F24C 15/16

(52) U.S. Cl. CPC A47J 43/18; A23L 17/00; A47G 19/30; A23V 2002/00; A22C 25/18; A22C 25/145; F24C 15/16; A22C 25/08

(57) ABSTRACT

This invention is a simplified method of cooking a whole fish without the problems associated with having to eat around fish bones or overcooking the fish. The whole fish is sliced open along the bottom side, the bones are removed, and the remaining fish meat is placed over a an upside-down “V” shaped stand for cooking for grilling.

### CROSS-REFERENCE TO RELATED APPLICATION

The present application claims priority to U.S. provisional patent application No. 62/334,030 as filed May 10, 2016.

### STATEMENT REGARDING FEDERALLY SPONSORED RESEARCH

Not applicable.

### NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND ON THE INVENTION

### 1. Field of the Invention

The present invention relates generally to cooking, particularly cooking seafood.

### 2. Description of the Related Art

Cooking whole fish can be a daunting taste for even the most seasoned chefs. Although there are variations to how to cook the fish—grilling, broiled, fried—it often requires very careful attention to ensure that the fish is fully cooked, but not overcooked such that it dries out and is not as satisfying to eat.

Positioning the fish to be cooked can also be an issued. If cooked on a flat surface, one must be careful to prevent the bottom from sticking to the pan and receiving too much of the juices from the fish which will make the protein soft and watery. One must also be careful to avoid breaking the fish when rolling it over.

There are additional issued when cooked on a grill over hot coals or a grill, or even baked as one should avoid the use of extra fat to prevent the fish skin sticking to the surface on the grill or pan on which it lies.

Finally, there are the issues associated with having to remove the bones from the whole fish. This is true even more so in industrialized countries where most consumers are not used to having bones in the seafood that they purchase, and they have grown accustomed to that convenience.

There are other known inventions that have tried to solve this same problem, but are deficient and different from the present invention.

US Patent Application Publication No. 2016/0022092 is similar to the present invention as both are a means to cook a whole fish in a more convenient way. However, this cited patent application fails to solve the issue of fewer to no bones in the whole fish being cooked and served at home or restaurant.

Thus, what is desired is a means of cooking a whole fish in a convenient way and without any, if possible, bones for the diners to have to eat around.

### SUMMARY

The present invention is a method for cooking a whole fish in a convenient way that eliminates most of the fish bones and allows cooking of the whole remaining fish without trying it out.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is an illustration of a stand according to the present invention.

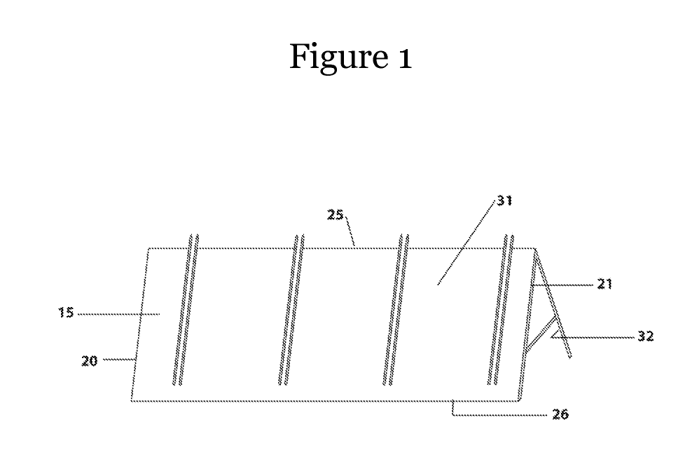

FIG. 2 is an illustration of a whole fish resting on the stand according to the present invention.

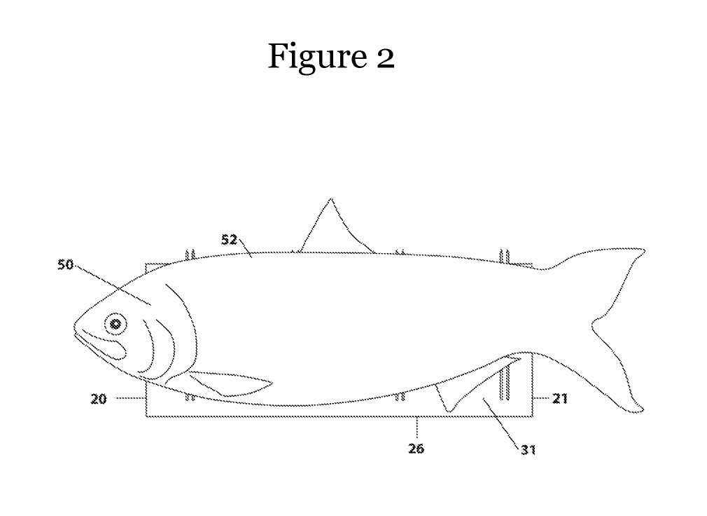

### DESCRIPTION OF THE REFERENCED NUMERALS

In reference to the drawings, similar reference characters denote similar elements throughout all the drawings. The following is a list of the reference characters and associated element:

15 Plane

20 Anterior

21 Posterior

25 Proximal Edge

26 Distal Edge

31 Exterior

32 Interior

50 Fish

52 Dorsal Side

### DETAILED DESCRIPTION

The present invention is a process for uniquely cooking a whole fish in a convenient way that eliminates most bones and allows for cooking the fish without drying it out.

In a first step, a fish is gutted and deboned by slicing the fish lengthwise along its ventral side. The slicing along the ventral side may slice all the way to the vertebrae of the fish. The guts of the fish are removed, and the vertebrae and ribs are removed. This leaves the fish meat still connected to the fish skin, and the fish skin is still substantially all connected except where sliced along the ventral side.

The fish head, tail, or both may also be kept connected and not removed with the guts and bones.

The remaining whole fish may then be descaled if desired.

The remaining whole fish may then be frozen or kept chilled.

The remaining whole fish may then be placed on a stand that is substantially shaped as multiple upside-down “V” posts connected at the uppermost point by a connecting rod. The interior portion of the dorsal side of the whole fish is placed so it rests on the top of the connecting rod and then the fish meat and skin drape against the upside V posts.

There may be at least two planes forming an inverted “V” shape with an angle of about between about 30 degrees and about 120 degrees between the two planes. Each of the two planes have an anterior and posterior, exterior side, interior side, and an adjoining proximal edge and opposing and respective distal edges. One or more reinforcing bars may be between the interior sides of the opposing planes.

It is preferred that there are multiple liner cutting slits directed from the proximal edge of each plane and directed towards the respective distal edge of each plane and substantially similar in length in each plane such that each slit is preferably between about 50% and 95% of the length between the proximal and distal edges. The slits include stakes directed upward and away from the proximal and distal edges

In an exemplary embodiment, a rod runs substantially parallel to the proximal edge and distal edges between the interior of the planes, and the rod can be attached to a conventional rotisserie mechanism.

In another embodiment, there is a holding plate beneath the stand to collect drippings from the cooking fish that can then cook back off the plate and heat the interior of the fish.

The rack is able to be frozen as well as be heated in a conventional oven.

The stand with the whole fish may then be baked or grilled on the stand. By having the interior slightly open by the stand, the fish bakes more fully, and the interior is kept moist by the steam that develops and held under the draped fish on the stand.

Once cooked, the stand and fish are removed from the oven or grill, and can be served directly from the stand if one desires. This gives the presentation and experience of eating a whole fish, but without having to worry about eating around bones or drying out the fish meat.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

What is claimed is:

1. A stand for holding a fish for consumption, the stand being comprised of:
at least two planes forming an inverted “V” shape with an angle of about between about 30 degrees and about 120 degrees between the two planes, wherein each of the two planes has an anterior and posterior, exterior side, interior side, and an adjoining proximal edge and opposing and respective distal edges;
multiple liner cutting slits directed from the proximal edge of each plane and directed towards the respective distal edge of each plane and substantially similar in length in each plane such that each slit is preferably between about 50% and 95% of the length between the proximal and distal edges.

2. The stand according to claim 1, wherein the slits include stakes directed upward and away from the proximal and distal edges.

3. The stand according to claim 1 further comprising one or more reinforcing bars between the interior sides of the opposing planes.

4. The stand according to claim 1, wherein the stand is able to be frozen.

5. The stand according to claim 1, wherein the stand is able to be used in an oven without substantially decomposing.

6. The stand according to claim 1, further comprising a holding plate.

7. The stand according to claim 1, further comprising a rod that runs substantially parallel to the proximal edge and distal edges between the interior of the planes, wherein the rod can be attached to a conventional rotisserie mechanism.

8. A method for providing a whole fish for consumption, the method including the steps of:
slicing the ventral side of a fish;
removing organs from the fish;
deboning the fish without removing skin and leaving the fish otherwise substantially intact;
positioning the fish on a stand, wherein the stand is comprised of:
at least two planes forming an inverted “V” shape with an angle of about between about 30 degrees and about 120 degrees between the two planes, wherein each of the two planes has an anterior and posterior, exterior side, interior side, and an adjoining proximal edge and opposing and respective distal edges;
multiple liner cutting slits directed from the proximal edge of each plane and directed towards the respective distal edge of each plane and substantially similar in length in each plane such that each slit is preferably between about 50% and 95% of the length between the proximal and distal edges,
wherein the fish rests against the exterior of each of the planes of the stand and the inside of the dorsal side of the fish is substantially adjacent to the proximal edge of the stand.

9. The stand according to claim 8, wherein the slits include stakes directed upward and away from the proximal and distal edges.

10. The stand according to claim 8 further comprising one or more reinforcing bars between the interior sides of the opposing planes.

11. The stand according to claim 8, wherein the stand is able to be frozen.

12. The stand according to claim 8, wherein the stand is able to be used in an oven without substantially decomposing.

13. The stand according to claim 8, further comprising a holding plate.

14. The stand according to claim 8, further comprising a rod that runs substantially parallel to the proximal edge and distal edges between the interior of the planes, wherein the rod can be attached to a conventional rotisserie mechanism.
